(19) United States
(12) Patent Application Publication
(10) Pub. No.: US 2004/0120495 A1
(43) Pub. Date: Jun. 24, 2004

(54) Method of disabling call-waiting before receiving incoming fax

(76) Inventors: Steven A. Rice, Shelbyville, KY (US); Douglas L. Robertson, Lexington, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/328,903

(22) Filed: Dec. 24, 2002

(51) Int. Cl. H04M 3/42

(52) U.S. Cl. 379/215.01

(57) ABSTRACT

A method of disabling call-waiting before receiving incoming digital data. An incoming call is answered by connecting a first line and a second line. The first line is then connected to a third line of a three-way calling feature. A dial tone is detected on the third line. A call-waiting disable signal is transmitted over the third line. The connection between the first line and the third line is terminated. The digital data is then received over the first line and the second line.

### BACKGROUND OF THE INVENTION

1. Field of the Invention

The present invention relates to facsimile machines, and, more particularly, to the use of facsimile machines on telephone lines using a call-waiting feature.

2. Description of the Related Art

Digital control of telephony has led to advancement of intelligent network standards for the public switched telephone network (hereafter the “PSTN”). AS viewed herein, the PSTN is the aggregate world-wide of all instrumentalities operating to interconnect telephones used by the public at large (both land-based and cellular/radio type telephones), but excluding privately deployed facilities which serve specific users or corporate employees (e.g. private networks formed by PBX's, Centrexes, etc.) as well as public data networks such as the Internet, World-Wide Web, etc.

Many conventional telephones have a catch-phone (hereinafter “call-waiting”) device that, if there is a call from a third party to a first party while the first party is conducting a conversation with a second party, the first party receives a “beep” from the exchange carrier. The first party may then signal the exchange carrier to then switch the first party's telephone line connection from the second party to the third party. The first party may then switch back to the second party by using the same call-waiting device to switch the line connection. Therefore, this type of telephone apparatus can substantially eliminate incidents where a caller is kept waiting due to a continual busy state of a called party's telephone.

The integrity of facsimile data transmitted via the PSTN is susceptible to any sort of noise that occurs on the line. However, most noise is random noise that is short in duration, which can easily be filtered out. Another example of noise would be a call-waiting tone. Unlike random noise, a call-waiting tone is quite long in duration (approximately 500 msec), which can easily compromise the data integrity. If compromised, the data must either be re-transmitted, increasing the overall duration of the transmission, or a premature termination of the facsimile transmission may occur. In each of these scenarios, a longer than necessary toll call, or the need to scrap an incomplete facsimile document may occur.

Within the United States today, most regional telephone networks support several calling features, including call-waiting, temporary call-waiting disable, and three-way calling. Small businesses, who are typical subscribers to these types of services, commonly use inkjet-based products. All-In-One (AIO) devices, which may contain printing, scanning, copying, and faxing functions, are more and more becoming the products of choice of these users. The users of AIO products that offer fax functionality could benefit from the ability to disable call-waiting from both incoming and outgoing facsimile transmissions.

It is commonly known that call-waiting can be disabled prior to initiating an outgoing call by dialing a call-waiting disable string, usually *70, before dialing the target phone number. However, it is not commonly known that most regional phone systems support the ability to disable call-waiting during a call.

What is needed in the art is a method of disabling call-waiting after a call is answered but before digital data is transmitted.

### SUMMARY OF THE INVENTION

The present invention provides a method of disabling call-waiting by answering an incoming fax, switching to a third line of a three-way calling feature, transmitting a disable call-waiting signal over the third line, and resuming reception of the incoming fax.

The invention comprises, in one form thereof, a method of disabling call-waiting before receiving incoming digital data. An incoming call is answered by connecting a first line and a second line. The first line is then connected to a third line of a three-way calling feature. A dial tone is detected on the third line. A call-waiting disable signal is transmitted over the third line. The connection between the first line and the third line is terminated. The digital data is then received over the first line and the second line.

An advantage of the present invention is that call-waiting may be disabled upon answering an incoming fax.

Another advantage is that call-waiting need not be separately disabled on a line prior to receiving a fax on that same line. Yet another advantage is that the fax machine automatically disables call-waiting.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a flowchart illustrating an initial user installation in the present invention for disabling call-waiting before receiving an incoming fax;

FIG. 2 is a flowchart of an embodiment of the present invention for disabling call-waiting before receiving an incoming fax; and

FIG. 3 is a flow chart of another embodiment of the present invention for disabling call-waiting before receiving an incoming call.

Corresponding reference characters indicate corresponding parts throughout the several views. The exemplification set out herein illustrates one preferred embodiment of the invention, in one form, and such exemplifications is not to be construed as limiting the scope of the invention in any manner.

### DETAILED DESCRIPTION OF THE INVENTION

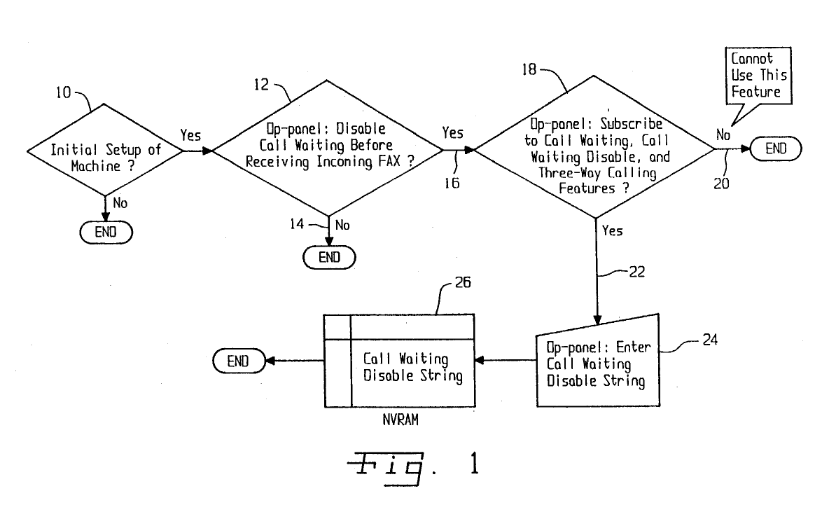

Referring now to the drawings and particularly to FIG. 1, there is shown an embodiment of a flow chart for an initial user installation of a facsimile machine used in the method of the present invention for disabling call-waiting before receiving an incoming fax. The initial user installation is carried out using an operating panel at the front of the facsimile machine for querying information and receiving input from the user.

At decision block 10, a determination is made as to whether an initial user installation is being performed. During initial user installation, the user is queried whether call-waiting is to be disabled before receiving an incoming fax (decision block 12). If the user does not wish to disable call-waiting (line 14), then the procedure terminates. On the other hand, if the user does desire to disable call-waiting before receiving an incoming fax (line 16), then the user is queried as to whether the features call-waiting, call-waiting disable, and three-way calling are subscribed to (decision block 18). The method of disabling call-waiting of the present invention requires all three of these features; therefore, if one or more of these features are not subscribed to then the procedure ends (line 20). The user may optionally be advised that the phone system does not support canceling call-waiting.

On the other hand, if the user desires to disable call-waiting before receiving an incoming fax, and each of the features call-waiting, call-waiting disable, and three-way calling are subscribed to (line 22), then the user is prompted to enter a call-waiting disable string, such as *70 or other suitable data code (block 24). The call-waiting disable string which is inputted by the user is then stored in a non-volatile memory 26, and the procedure ends.

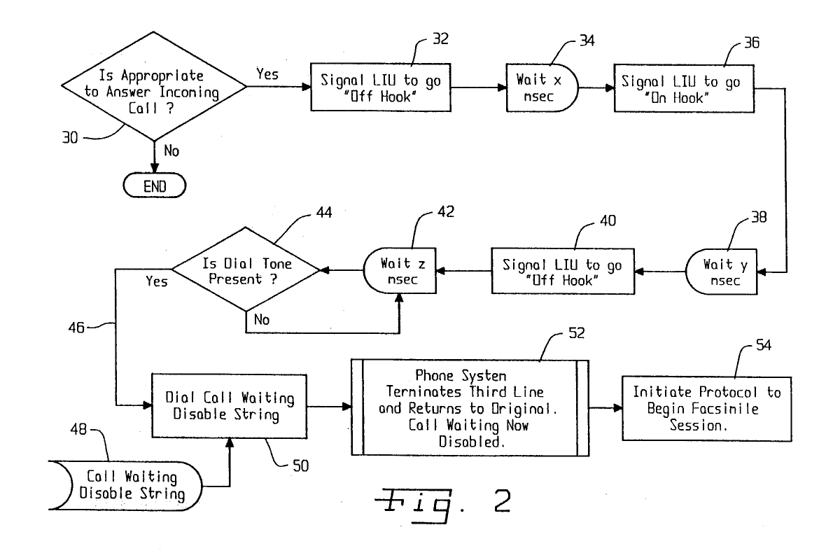

Referring now to FIG. 2, there is shown an embodiment of a method of the present invention for disabling call-waiting prior to receiving an incoming fax. At decision block 30, a decision is made to answer an incoming fax call. Upon receipt of the incoming fax call, a line interface unit (LIU) is signaled to go “off hook”, meaning that a first line associated with the fax machine is connected to a second line carrying the incoming fax call (block 32). After a predetermined amount of time, which may vary depending upon the fax machine or application, (block 34), the LIU is signaled to go “on hook”, or in other words hang up (block 36). After a predetermined amount of time (block 38), the LIU is then signaled to again go “off hook” (block 40). A delay period of a predetermined duration (block 42) is set to determine the presence of a dial tone on the third line (decision block 44). If a dial tone is present on the third line (line 46), then a call-waiting disable string is retrieved from a non-volatile memory 48 and transmitted to the phone system (block 50). Upon receipt of the call-waiting disable string, the phone system terminates the connection with the third line associated with the three-way calling feature and returns to the original connection between the first line and second line (block 52). At this point, call-waiting is disabled and remains so for the duration of the incoming fax call. The fax machine then initiates the protocol to begin fax data reception (block 54).

In the method of the present invention shown in FIG. 2 and described above, the digital data is in the form of facsimile data transmitted to a facsimile machine. However, it is also possible that the digital data may be other types of digital data, such as for use with a modem forming part of a personal computer (PC).

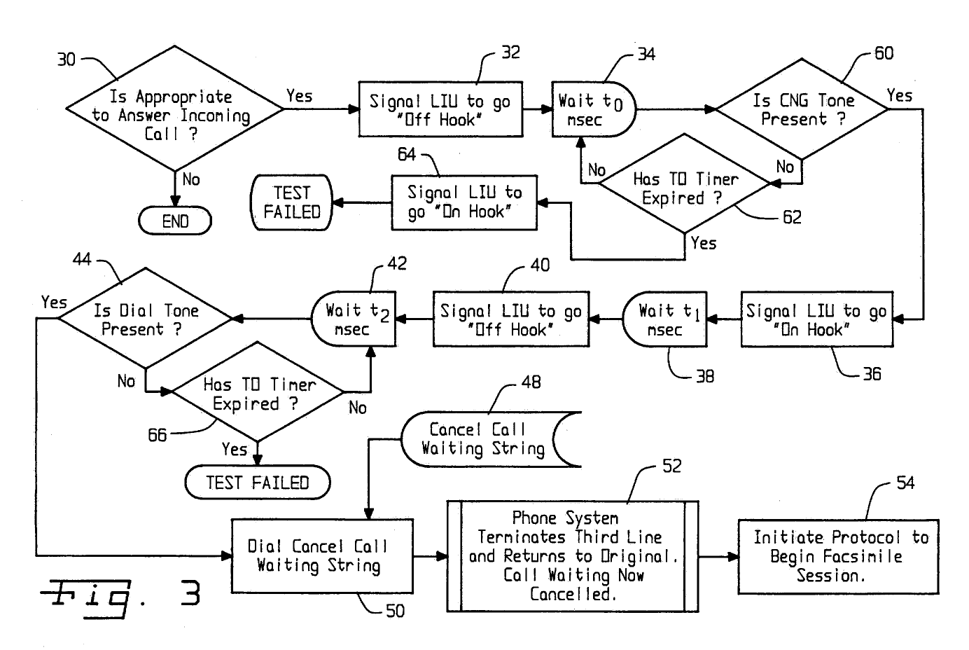

Referring now to FIG. 3, there is shown another embodiment of a method of the present invention for disabling call-waiting prior to receiving an incoming fax. The flow chart in FIG. 3 is similar in many respects to the flow chart illustrated and described above with respect to FIG. 2. The flow chart in FIG. 3 principally differs in that it includes a decisional loop to detect the presence of a fax tone (known as a CNG tone) at the initiation of an incoming call, and a decisional loop associated with detection of the dial tone on the third line associated with the 3-way calling feature. More particularly, at decisional block 60, decisional block 62 and block 34, a wait state occurs to determine whether a CNG tone is present upon connection of the incoming call. Decisional block 60 detects the presence of the CNG tone. If no CNG tone is present, a determination is made as to whether the total time to determine the CNG tone has exceeded a time (T0) period (typically a duration of approximately 60 seconds). If no fax tone has been detected and the time out timer has expired, then the LIU is signaled to go “on hook” (block 64). The wait station defined by block 42, decisional block 44 and decisional block 66 is similar in that a wait state occurs for detection of the dial tone on the third line for a time period corresponding to the time out period (T0).

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of disabling call-waiting before receiving incoming digital data, comprising the steps of:
answering an incoming call by connecting a first line and a second line;
connecting said first line to a third line of a three-way calling feature;
detecting a dial tone on said third line;
transmitting a call-waiting disable signal over said third line;
terminating said connection between said first line and said third line; and
receiving the digital data over said first line and said second line.

2. The method of disabling call-waiting of claim 1, wherein said answering step comprises signaling a line interface unit to go off hook.

3. The method of disabling call-waiting of claim 1, wherein said connecting step comprises the substeps of:
signaling said line interface unit to go on hook;
pausing a predetermined amount of time; and
signaling said line interface unit to go off hook

4. The method of disabling call-waiting of claim 1, wherein said digital data comprises facsimile data.

5. The method of disabling call-waiting of claim 4, including the further step of performing an initial user installation on a facsimile machine, including the substeps of:
determining if the user subscribes to each of call-waiting, temporary call-waiting disable, and three-way calling; and
determining if the user desires to disable call-waiting on incoming calls.

6. The method of disabling call-waiting of claim 5, wherein said step of performing said initial user installation includes the further substep of inputting said call-waiting disable signal from the user.

7. The method of disabling call-waiting of claim 6, including the further step of storing said call-waiting disable signal in a non-volatile memory.

8. A method of disabling call-waiting on a telephone line before receiving incoming digital data, comprising the steps of:
answering an incoming call on a first line;
connecting said first line to a third line of a three-way calling feature;
transmitting a call-waiting disable signal over said third line;
reconnecting said first line with said incoming call; and
receiving the digital data over said first line.

9. The method of disabling call-waiting of claim 8, wherein said digital data comprises facsimile data.

10. The method of disabling call-waiting of claim 9, including the further step of performing an initial user installation on a facsimile machine, including the substeps of:
determining if the user subscribes to each of call-waiting, temporary call-waiting disable, and three-way calling; and
determining if the user desires to disable call-waiting on incoming calls.

11. The method of disabling call-waiting of claim 10, wherein said step of performing said initial user installation includes the further substep of inputting said call-waiting disable signal from the user.

12. The method of disabling call-waiting of claim 11, including the further step of storing said call-waiting disable signal in a non-volatile memory.

13. A method of disabling call-waiting before receiving incoming digital data, comprising the steps of:
answering an incoming call by connecting a first line and a second line;
connecting said first line to a third line of a three-way calling feature;
transmitting a call-waiting disable signal over said third line;
reconnecting said first line with said second line; and
receiving the digital data over said first line and said second line.

14. The method of disabling call-waiting of claim 13, wherein said digital data comprises facsimile data.

15. The method of disabling call-waiting of claim 14, including the further step of performing an initial user installation on a facsimile machine, including the substeps of:
determining if the user subscribes to each of call-waiting, temporary call-waiting disable, and three-way calling; and
determining if the user desires to disable call-waiting on incoming calls.

16. The method of disabling call-waiting of claim 15, wherein said step of performing said initial user installation includes the further substep of inputting said call-waiting disable signal from the user.

17. The method of disabling call-waiting of claim 16, including the further step of storing said call-waiting disable signal in a non-volatile memory.
